(19) United States
(12) Patent Application Publication
(10) Pub. No.: US 2022/0067480 A1
(43) Pub. Date: Mar. 3, 2022

(54) RECOGNIZER TRAINING DEVICE, RECOGNITION DEVICE, DATA PROCESSING SYSTEM, DATA PROCESSING METHOD, AND STORAGE MEDIUM

(71) Applicant: NEC Corporation, Minato-ku, Tokyo (JP)

(72) Inventor: Hiroo IKEDA, Tokyo (JP)

(73) Assignee: NEC Corporation, Minato-ku, Tokyo (JP)

(21) Appl. No.: 17/420,229

(22) PCT Filed: Jan. 25, 2019
(86) PCT No.: PCT/JP2019/002475

§ 371 Date: Jul. 1, 2021

(51) Int. Cl. G06N 3/02; G06K 9/62

(52) U.S. Cl. CPC G06N 3/02; G06K 9/6232; G06K 9/6259

(57) ABSTRACT

The disclosure is training a recognizer that outputs a recognition result by using a time series of feature data as an input. In addition, the disclosure is setting a data range whose length is a specified time width to a set of feature data to which a time is added, and selecting a specified number of pieces of the feature data from within the data range; adding a teacher label corresponding to the recognition result to the selected plurality of pieces of feature data, whose time order is retained, based on information regarding the plurality of pieces of feature data; and training the recognizer by using, as training data, a set of the plurality of pieces of feature data, whose time order is retained, and the teacher label.

### TECHNICAL FIELD

The present disclosure relates to a technique for performing recognition using time series data.

### BACKGROUND ART

A technique of recognizing (also referred to as identifying) a behavior and the like of a person using time series data is known.

The behavior determination method described in PTL 1 obtains new time series data by time series analyzing time series data (original time series data) obtained from a sensor while moving along a time axis with a predetermined time width. In this behavior determination method, behavior is determined by inputting the new time series data to a neural network. This technique is based on the premise that time series data is obtained from the sensor at constant time intervals.

An action identification device described in PTL 2 acquires a time series velocity vector from time series moving image data, and obtains a time series Fourier-transformed vector by Fourier-transforming the velocity vector. Moreover, the action identification device obtains a pattern vector having all Fourier-transformed vectors within a predetermined time range as components. The action identification device identifies an action of a person included in the moving image data by inputting the obtained pattern vector to a neural network. This technique also assumes that the CCD camera obtains moving image data at constant sample time intervals.

### CITATION LIST

### Patent Literature

### [PTL 1] JP 2007-220055 A

### [PTL 2] JP 2000-242789 A

### SUMMARY OF INVENTION

### Technical Problem

The techniques described in PTL 1 and PTL 2 are based on the premise that the time series data is acquired at predetermined time intervals. A case where the time intervals of the time series data used for optimization (that is, learning) of the neural network functioning as a recognizer (also referred to as a discriminator) are different from the time intervals of the time series data used for recognition is not considered. Therefore, for example, there may be cases where recognition cannot be performed well for time series data acquired at time intervals longer than time intervals of the time series data used for learning. The reason is that the number of pieces of data per unit time in the time series data used for recognition is smaller than the number of pieces of data per unit time in the time series data used for learning, and when data included in a certain time range is acquired and recognition is performed, recognition cannot be executed due to data shortage. The reason why the data shortage occurs is that it is on the premise that all data included in a time range of a certain length are used in both learning and recognition.

In a case where the time series data for recognition is not acquired at predetermined time intervals (for example, in a case where time series data at different time intervals is acquired due to an unstable communication environment), it is considered that recognition cannot be executed well. In a case where the number of pieces of data desired to be used for recognition is insufficient in the time range that is a target of recognition, the recognition cannot be executed. Even if the number of pieces of data is sufficient, since learning is performed using time series data at constant time intervals at the time of learning, there is a possibility that the recognizer generated by the learning does not give an accurate recognition result for the time series data at non-constant time intervals.

It is an object of the present invention to provide a training device, a training method, and the like that enable generation of a recognizer that does not depend on time intervals in acquisition of time series data. It is also an object of the present invention to provide a recognition device, a recognition method, and the like that enable recognition that does not depend on time intervals in acquisition of time series data.

### Solution to Problem

A recognizer training device according to one aspect of the present invention is a recognizer training device that trains a recognizer that outputs a recognition result by using a time series of feature data as an input, the recognizer training device including a training feature data selection means for setting a data range whose length is a specified time width to a set of feature data to which a time is added, and selecting a specified number of pieces of the feature data from within the data range, a label addition means for adding a teacher label corresponding to the recognition result to a plurality of pieces of feature data, which is selected by the training feature data selection means and whose time order is retained, based on information regarding the plurality of pieces of feature data, and a training means for training the recognizer by using, as training data, a set of the plurality of pieces of feature data, whose time order is retained, and the teacher label added by the label addition means.

A recognition device according to one aspect of the present invention includes a recognition feature data selection means for setting a data range whose length is a specified time width to a set of feature data to which a time is added, and selecting a specified number of pieces of the feature data from within the data range, a recognition means for deriving a recognition result by inputting, to a recognizer, a plurality of pieces of feature data, which is selected by the recognition feature data selection means and whose time order is retained, and an output means for outputting information based on the recognition result.

A data processing method according to one aspect of the present invention is a data processing method for training a recognizer that outputs a recognition result by using a time series of feature data as an input, the data processing method including setting a data range whose length is a specified time width to a set of feature data to which a time is added, and selecting a specified number of pieces of the feature data from within the data range, adding a teacher label corresponding to the recognition result to the selected plurality of pieces of feature data, whose time order is retained, based on information regarding the plurality of pieces of feature data, and training the recognizer by using, as training data, a set of the plurality of pieces of feature data, whose time order is retained, and the teacher label.

A data processing method according to one aspect of the present invention includes setting a data range whose length is a specified time width to a set of feature data to which a time is added, and selecting a specified number of pieces of the feature data from within the data range, deriving a recognition result by inputting, to a recognizer, the selected plurality of pieces of feature data, whose time order is retained, and outputting information based on the recognition result.

A storage medium according to one aspect of the present invention stores a program for training a recognizer that outputs a recognition result by using a time series of feature data as an input, the program causing a computer to execute feature data selection processing of setting a data range whose length is a specified time width to a set of feature data to which a time is added, and selecting a specified number of pieces of the feature data from within the data range, label addition processing of adding a teacher label corresponding to the recognition result to a plurality of pieces of feature data, which is selected by the feature data selection processing and whose time order is retained, based on information regarding the plurality of pieces of feature data, and training processing of training the recognizer by using, as training data, a set of the plurality of pieces of feature data, whose time order is retained, and the teacher label added by the label addition processing.

A storage medium according to one aspect of the present invention stores a program for causing a computer to execute feature data selection processing of setting a data range whose length is a specified time width to a set of feature data to which a time is added, and selecting a specified number of pieces of the feature data from within the data range, recognition processing of deriving a recognition result by inputting, to a recognizer, a plurality of pieces of feature data, which is selected by the feature data selection processing and whose time order is retained, and output processing of outputting information based on the recognition result.

### Advantageous Effects of Invention

According to the present invention, it is possible to generate a recognizer that does not depend on time intervals in acquisition of time series data. According to the present invention, it is possible to perform recognition that does not depend on time intervals in acquisition of time series data.

### BRIEF DESCRIPTION OF DRAWINGS

FIG. 1 is a block diagram illustrating a configuration of a data processing system according to a first example embodiment of the present invention.

FIG. 2 is a diagram illustrating an example of information included in sample data.

FIG. 3 is a diagram illustrating an example of information included in recognition target data.

FIG. 4 is a diagram conceptually illustrating an example of weighting probability in selection of feature data.

FIG. 5 is a flowchart illustrating an example of a flow of processing of training by a training module according to the first example embodiment.

FIG. 6 is a diagram conceptually illustrating an example of shifting a data range.

FIG. 7 is a flowchart illustrating another example of a flow of processing of training by the training module according to the first example embodiment.

FIG. 8 is a flowchart illustrating an example of a flow of processing of recognition by a recognition module according to the first example embodiment.

FIG. 9 is a block diagram illustrating a configuration of a data processing system according to a first modification example of the first example embodiment.

FIG. 10 is a flowchart illustrating an example of a flow of processing of recognition by a recognition module according to the first modification example.

FIG. 11 is a block diagram illustrating a configuration of a data processing system according to a second modification example of the first example embodiment.

FIG. 12 is a flowchart illustrating an example of a flow of recognition processing by a recognition module according to a second modification example.

FIG. 13 is a block diagram illustrating a configuration of a recognizer training device according to one example embodiment of the present invention.

FIG. 14 is a flowchart illustrating a flow of a recognizer training method according to the one example embodiment of the present invention.

FIG. 15 is a block diagram illustrating a configuration of a recognition device according to the one example embodiment of the present invention.

FIG. 16 is a flowchart illustrating a flow of a recognition method according to the one example embodiment of the present invention.

FIG. 17 is a block diagram illustrating an example of hardware constituting units of each example embodiment of the present invention.

### EXAMPLE EMBODIMENT

Hereinafter, example embodiments of the present invention will be described in detail with reference to the drawings.

In the present disclosure, the terms “random” and “randomly” are used in the sense of including, for example, a method in which it is difficult to completely predict a result in advance. “Randomly select” means that selection is performed by a selection method that can be regarded as having no reproducibility in the selection result. Not only a selection method that depends only on a random number, but also a selection method using a pseudo random number and a selection method conforming to a predetermined probability distribution can be included in the random selection method.

### First Example Embodiment

First, a first example embodiment of the present invention will be described.

<Configuration>

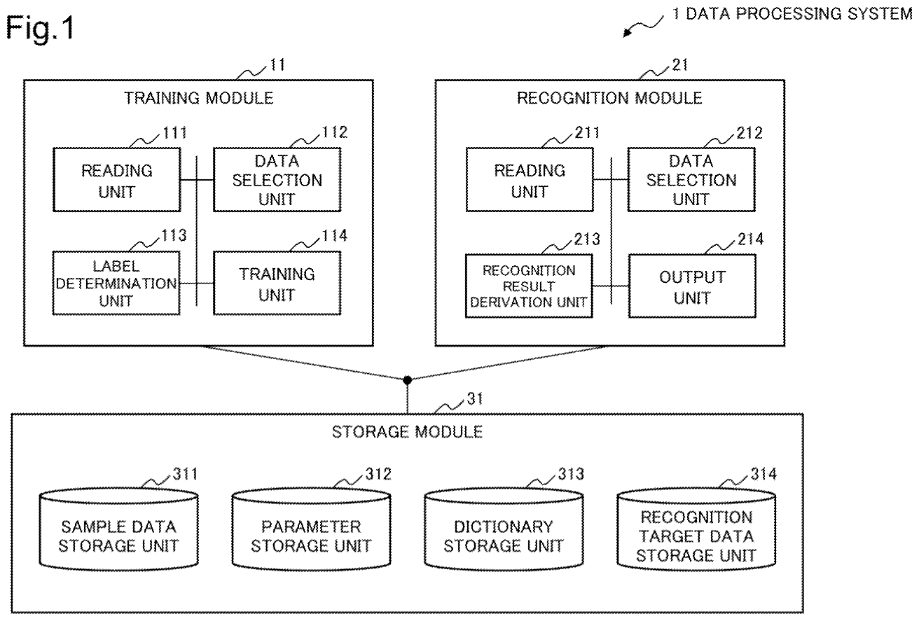

FIG. 1 is a block diagram illustrating a configuration of a data processing system 1 according to the first example embodiment.

The data processing system 1 includes a training module 11, a recognition module 21, and a storage module 31. In the present disclosure, a “module” is a concept indicating a group of functions. The module may be one object, or may be a combination of a plurality of objects or a portion of one object that is apprehended as conceptually integrated.

The storage module 31 is a module that stores information used by the training module 11 and the recognition module 21.

The recognition module 21 is a module that performs recognition. Specifically, recognition performed by the recognition module 21 is to derive one recognition result by using a recognizer constructed on the basis of a dictionary (described later) stored in the storage module 31 and using a plurality of pieces of feature data as inputs. The recognizer may be a known recognizer, and for example, a support vector machine (SVM), a random forest, a recognizer using a neural network, or the like may be employed. The purpose of recognition is, for example, identification of behavior of an observation target (person or object), acquisition of knowledge regarding a state of the observation target, detection of a person or object performing a predetermined behavior, detection of a person or object in a predetermined state, detection of occurrence of an event, or the like. As an example, for the purpose of identifying the behavior of the observation target (person or object), the recognizer outputs one of a plurality of behaviors prepared as behaviors that can be taken by the observation target as the behavior of the observation target on the basis of a plurality of pieces of feature data. Specifically, for example, the recognizer performs calculation using a plurality of pieces of feature data as input, determines one behavior among the plurality of behaviors as a result of the calculation, and outputs information indicating the determined behavior. Alternatively, the recognizer may be configured to output the likelihood of each of the plurality of behaviors.

The training module 11 is a module that performs training of a dictionary.

The “dictionary” in the present disclosure refers to data that defines a recognizer for performing recognition processing. The dictionary includes parameters whose values are correctable by training. The training of the dictionary means correcting the value of a parameter in the dictionary using the training data. The training of the dictionary is expected to improve accuracy of recognition using the recognizer based on the dictionary. Training the dictionary can also be said to be training the recognizer.

Each module (that is, in the present example embodiment, the training module 11, the recognition module 21, and the storage module 31) may be implemented by, for example, separate devices, or may be partially or entirely implemented by one computer. Each module may be configured to be capable of exchanging data with each other. When the modules are implemented by separate devices, each of the devices may be configured to communicate data with each other via a communications interface. In one example embodiment, the storage module 31 may be a portable recording medium, and the device constructing the training module 11 and the device constructing the recognition module 21 may include an interface for reading data from the portable recording medium. In this case, the portable recording medium may be connected to both devices at the same time, or a person may switch the device to which the portable recording medium is connected according to the situation.

A set of a plurality of devices may be regarded as a module. That is, the entity of each module may be a plurality of devices. Components included in different modules may be implemented in one device.

When generating or acquiring data, each component included in the training module 11 and the recognition module 21 may make the data available to other components. For example, each component may deliver the generated or acquired data to other components that use the data. Alternatively, each component may record the generated or acquired data in a storage area (memory or the like, not illustrated) in a module including the component or in the storage module 31. Each component may directly receive data to be used from the component that has generated or acquired the data or read the data from the storage area or the storage module 31 when executing each processing.

Hereinafter, the function of each module will be described in detail.
Storage Module 31

The storage module 31 includes a sample data storage unit 311, a parameter storage unit 312, a dictionary storage unit 313, and a recognition target data storage unit 314.

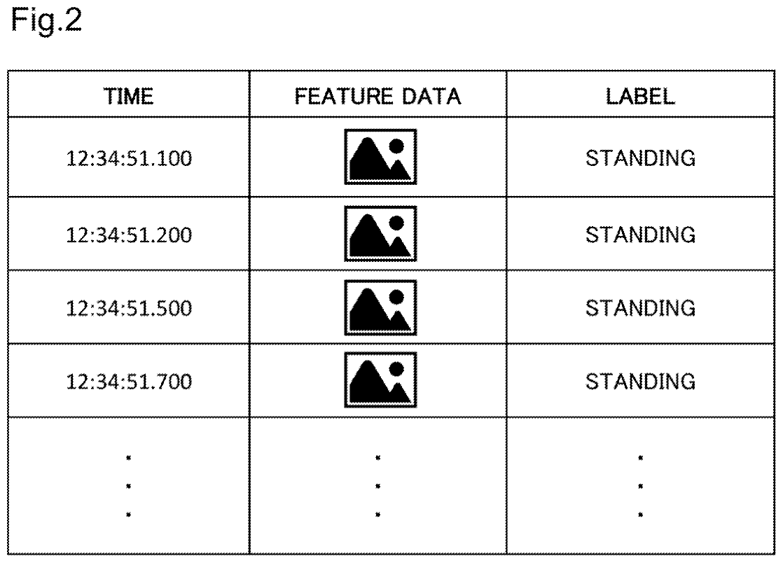

The sample data storage unit 311 stores sample data. The sample data is data used to generate a sample (what is called a training sample) used for training a trainer by the training module 11. The sample data of the present example embodiment is a collection of feature data to which information indicating a time and a label are added. FIG. 2 is a diagram conceptually illustrating an example of information included in the sample data. The sample data does not necessarily need to be stored in a tabular form as illustrated in FIG. 2, but it is easy to handle if the sample data is stored in a state in which the time series relationship is easy to understand, such as being arranged in order of time.

The feature data is data representing a feature of a target recognized by the recognizer. The feature data is, for example, data obtained by a camera, another sensor, or the like, or data generated by processing the data. Specifically, examples of the data obtained from the camera include a color image and a grayscale image and the like. The feature data may be data representing the entire image acquired by the camera or may be data representing a part of the image. Examples of data generated by processing data include a normalized image, an interframe difference image, a feature amount extracted from the image and representing a feature of an object appearing in the image, a pattern vector obtained by performing conversion processing on the image, and the like.

Examples of the information obtained from the sensor other than the camera include, but are not limited to, an acceleration, a position, a distance to the sensor, a temperature, and the like of an object (which may be a part of a living body).

The information indicating the time added to the feature data indicates a time when the feature data is observed. For example, in a case where an image is acquired by image capturing and feature data is extracted from the image, the information indicating the time added to the feature data indicates not the time when the feature data is extracted from the image but the time when the image-capturing is executed. In the present disclosure, a state that information indicating the time is added to feature data is also expressed as that a time is added to feature data.

Time intervals at which each piece of feature data is observed may be constant or indefinite.

The label assumed in the present example embodiment is, for example, information indicating the behavior of the observation target, such as “standing” or “sitting”. The label does not need to be text information that can be understood by a person, and is only required to be information for identifying the type of the label.

What is indicated by the label is not limited to human behavior. The label may be, for example, information indicating an action given to an object, such as “thrown” or “placed”, or may be information indicating an event, such as “vehicle intrusion” or “occurrence of line”.

The label is only required to be added by, for example, an observer who has observed the state of the observation target in the sample data. For example, when the observer determines that the observation target exhibits a predetermined behavior in a certain period, the observer is only required to add a label indicating the predetermined behavior to each piece of feature data included in the period. The method of adding a label by the observer may be a method of inputting, to a computer that controls the storage module, feature data or information specifying a period and identification information indicating a label via an input interface.

Instead of the observer, a computer capable of recognizing behavior may give a label to each piece of feature data.

The parameter storage unit 312 stores values of parameters (hereinafter referred to as “specified parameters”) referred to in the training and recognition. Specifically, contents represented by the specified parameters are a specified time width and the specified number of pieces of data.

The specified time width is a length specified as a length (time width) of a range in which the feature data is to be extracted in time series data. The specified time width can be expressed as, for example, “four (seconds)” or the like.

The specified number of pieces of data is a number specified as the number of pieces of feature data to be selected from the specified time width. The specified number of pieces of data can be expressed as, for example, “six (pieces)” or the like.

The specified time width and the specified number of pieces of data may be determined, for example, at the time of implementation of the data processing system 1, or may be specified by receiving a specification by an input from the outside.

The dictionary storage unit 313 stores a dictionary. The dictionary is trained by the training module 11 and used for recognition processing by the recognition module 21. As described above, the dictionary is data defining the recognizer, and includes data defining a recognition process and a parameter used for calculation. For example, in an example embodiment in which the recognizer using a neural network is employed, the dictionary includes data defining a structure of the neural network and a weight and a bias that are parameters. The content and data structure of the dictionary is only required to be appropriately designed according to the type of the recognizer.

The recognition target data storage unit 314 stores recognition target data. The recognition target data is data on which data to be a target of recognition by the recognition module 21 is based. That is, data to be a target of recognition by the recognition module 21 is created from a part of the recognition target data.

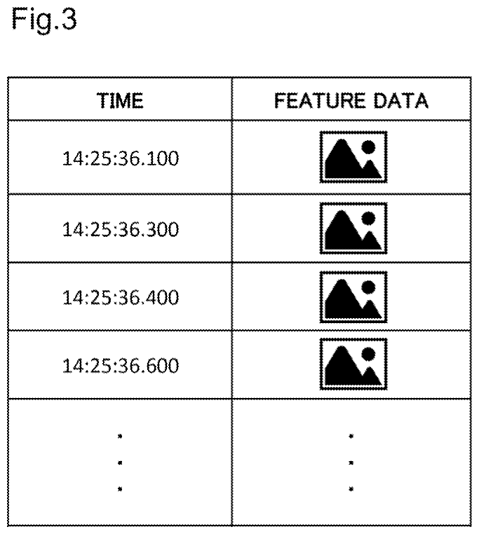

The recognition target data storage unit 314 stores feature data to which a time is added. FIG. 3 is a diagram illustrating an example of information included in recognition target data.

The feature data included in the recognition target data can be acquired from, for example, a feature data acquisition device (not illustrated) that acquires feature data by sensing. For example, the feature data acquisition device is only required to store data obtained from a camera, other sensors, or the like, or data generated by processing the data in the recognition target data storage unit 314 in order of acquisition time.

The time and the feature data are similar to the time and the feature data of the sample data as already described. The time intervals of data included in the recognition target data may be constant or indefinite.
Training Module 11

The training module 11 includes a reading unit 111, a data selection unit 112, a label determination unit 113, and a training unit 114.

The reading unit 111 reads data to be used for processing by the training module 11 from the storage module 31. The data read by the reading unit 111 is, for example, the sample data stored in the sample data storage unit 311, the specified parameters stored in the parameter storage unit 312, and the dictionary stored in the dictionary storage unit 313.

The data selection unit 112 selects a number of pieces of feature data equal to the specified number of pieces of data among the sample data as feature data to be used for training. At this time, the data selection unit 112 sets a data range having a length corresponding to the specified time width in the sample data, and then selects the number of pieces of feature data that is equal to the specified number of pieces of data from the feature data included in the range.

A determination method for the data range may be, for example, a method of determining the data range with reference to a certain time (for example, using the time as a start point, an end point, or a center point). The “certain time” may be a specified time or may be a time randomly determined (for example, by a method using a random number or a pseudo random number) from a range of possible times given to the sample data. Alternatively, the determination method for the data range may be, for example, a method of selecting one piece of feature data included in the sample data and determining the data range with reference to this feature data (for example, using the time added to the feature data as a start point, an end point, or a center point). The feature data selected in this case may be specified feature data or randomly determined feature data. In the above example, in a case where the specified time or the specified feature data is used, such specification is only required to be acquired, for example, by the training module 11 receiving the specification from the outside via an input interface (not illustrated) or by the storage module 31 storing such specification and the reading unit 111 reading the specification.

The data selection unit 112 may set the data range by a setting method in which the data range is shifted every time the data range is set (a specific example will be described in the description of operation).

One example of a method of selecting feature data is a method of simply and randomly selecting the feature data. For example, the data selection unit 112 is only required to specify the number of pieces of feature data included in the determined data range, and select the number for a number corresponding to the specified number of pieces of data by a method of performing random selection without duplication from a set of numbers from No. 1 to the number corresponding to the specified number. As a method of performing random selection without duplication, for example, a selection method in which an operation of randomly selecting one (for example, by a method in which probabilities of selection of any number included in the set are equal) from a set of numbers excluding the selected number is repeated a predetermined number of times corresponds.

The data selection unit 112 may be configured to always select the latest feature data in the determined data range. In this case, it is sufficient if the data selection unit 112 selects the latest feature data, and selects n−1 pieces (n is the specified number of pieces of data, and the same applies hereinafter) of feature data (for example, by a method of performing random selection without duplication) among feature data other than the latest feature data.

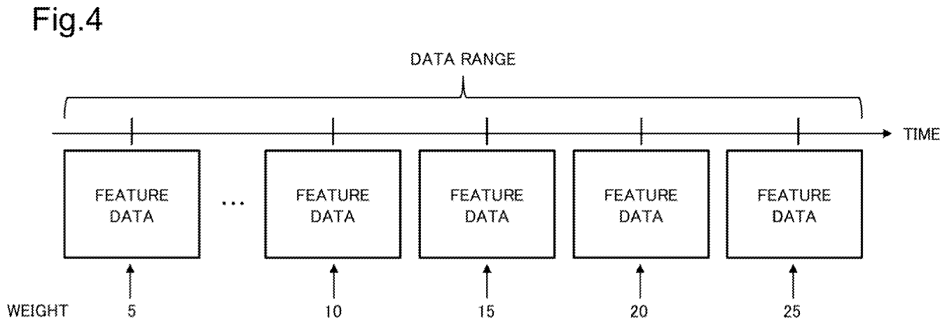

An example of another method of selecting feature data is a weighted random selection method. The weighted random selection method is a method of performing random selection on the basis of a probability according to the weight. For example, as illustrated in FIG. 4, the data selection unit 112 may set the weight to each piece of feature data included in the determined data range so that the weight to be selected becomes larger for feature data that is given a newer time (that is, in order to be easily selected). Then, it is sufficient if the data selection unit 112 selects n pieces of feature data by the weighted random selection method.

The above-described method of always selecting the latest feature data and the weighted random selection method such that the weight becomes larger for feature data that is given a newer time are particularly effective in the recognition in real time. The reason is that a newer time is more important in the recognition in real time, and the above methods are configured so that data at the newer time can be selected with emphasis.

An example of still another method of selecting feature data is a method of selecting feature data so that variations in the time intervals between the selected pieces of feature data are as small as possible. A specific example is presented below. The feature data described in this specific example all refer to feature data included in the determined data range. First, the data selection unit 112 determines feature data that is a reference and a reference interval. As the feature data that is the reference, for example, the oldest feature data (with the earliest added time) is determined. As the reference interval, for example, a quotient obtained by dividing the length of the data range (that is, the specified time width) by the specified number of pieces of data or a quotient obtained by dividing the time from a time added to the feature data that is the reference to a time added to the latest feature data by “the specified number of pieces of data−1” is determined. Then, the data selection unit 112 specifies a time after “reference interval×k” elapses from the time added to the feature data that is the reference. k is a variable that takes all integer values ranging from zero to n−1. Then, the data selection unit 112 sequentially selects, from k=zero to k=n−1, feature data whose added time is the closest to the time specified using k. However, the data selection unit 112 selects the feature data so that the same feature data is not selected at different times. According to the above example, the feature data selected for the time when k=zero is inevitably the feature data that is the reference.

As a modification example of the above example, the data selection unit 112 may select n pieces of feature data in which a vector having each of the specified times as a component and a vector having a time added to the selected n pieces of feature data as a component are the most similar (that is, the Euclidean distance is the smallest).

In the above example, the latest feature data may be used as the feature data that is the reference. In this case, as the reference interval, for example, a quotient obtained by dividing the length of the data range by the specified number of pieces of data or a quotient obtained by dividing the time from a time added to the feature data having the earliest added time to the time added to the feature data that is the reference by “the specified number of pieces of data−1” is determined. For each value of k, the data selection unit 112 specifies a time that is traced back by “reference interval×k” from the time added to the feature data that is the reference, and is only required to select, for the specified time, feature data whose added time is closest to the time.

As another example of the method of selecting feature data so that variations in the time intervals between the selected pieces of feature data are as small as possible, the data selection unit 112 may select feature data existing in each predetermined number of pieces in order of the time (may be either a forward direction or a reverse direction) added from the feature data that is the reference. For example, in a case where the specified number of pieces of data is n and the predetermined number of pieces is 3, the data selection unit 112 is only required to select “1+3 k”-th feature data (k is a variable from zero to n−1) among the plurality of pieces of feature data arranged in time series. The predetermined number of pieces may be determined in advance, may be specified on the basis of an input from the outside, or may be derived, on the basis of a relationship between the number of pieces of feature data included in the data range and the specified number of pieces of data, by a predetermined calculation equation (for example, a predetermined number of pieces=int(the number of pieces of feature data included in the data range/the specified number of pieces of data) or the like, where int(x) is a function that outputs an integer part of x).

The data selection unit 112 may add a flag indicating that feature data is selected to selected feature data among the feature data recorded in the sample data storage unit 311. Alternatively, the data selection unit 112 may read the selected feature data from the sample data storage unit 311 and output the feature data to other components or storage areas in the training module 11. In this case, the data selection unit 112 outputs the specified number of pieces of data n of the selected feature data in a temporally ordered state. For example, the data selection unit 112 may arrange n pieces of the selected feature data in descending order of the added time, and record the feature data in an arranged state in a storage area in the training module 11. Even when the selected feature data is not read from the sample data storage unit 311, the data selection unit 112 may add a flag indicating that the feature data is selected and information (number or the like) indicating a temporal hierarchy to the selected feature data among the feature data recorded in the sample data storage unit 311.

The label determination unit 113 determines a label to be given to the feature data selected by the data selection unit 112. One label is determined for the selected feature data group. Hereinafter, the label determined by the label determination unit 113 is also referred to as a “teacher label”. A set of the selected feature data group and the teacher label is the training sample.

The teacher label is information corresponding to data on an output side of the recognizer.

The label determination unit 113 extracts a label added to each piece of feature data selected by the data selection unit 112, and determines the teacher label on the basis of the extracted label.

For example, the label determination unit 113 may select a label having the largest number of labels added to the selected feature data among the extracted labels, and determine the selected label as the teacher label. For example, the label determination unit 113 may set a weight according to the time added to feature data of the extraction source to the extracted label, enumerate (in other words, cumulatively add) the number with the weight, and determine the label with the largest value (that is, the total value) as a result of the enumeration as the teacher label. The method of counting the number with a weight is a method of counting the number such that the larger the weight, the greater the influence on the total value. As an example, when there are three certain labels among the extracted labels, and the weights set to the three labels are 0.2, 0.5, and 0.7, the total value is calculated as 0.2+0.5+0.7=1.4.

The training unit 114 trains the dictionary stored in the dictionary storage unit 313 using the specified number of pieces of feature data selected by the data selection unit 112 and the teacher label determined by the label determination unit 113. Specifically, the training unit 114 sets a set of the specified number of pieces of selected feature data and the teacher label as one training sample, and corrects the values of the parameters included in the dictionary using the training sample. In the present disclosure, one or more training samples are also referred to as training data. It is sufficient if a known learning algorithm is employed as a training method.

The selected feature data is typically used in the training in a temporally ordered state (in other words, a state in which the added times are aligned so that the order of the added times can be known). Specifically, for example, if data received as the input of the recognizer is in a vector format, the selected data can be connected in the order of added time and treated as one vector. Alternatively, for example, if the feature data is a two-dimensional image and the recognizer is constructed by a neural network using data of a three-dimensional structure as an input, such as a convolutional neural network (CNN) or the like, the feature data is arranged in time order in a channel direction and can be treated as data of a three-dimensional structure. In the present disclosure, being in a temporally ordered state is also expressed by words “arranged in the time order” and “whose time order is retained”.
Recognition Module 21

The recognition module 21 includes a reading unit 211, a data selection unit 212, a recognition result derivation unit 213, and an output unit 214.

The reading unit 211 reads data to be used for processing by the recognition module 21 from the storage module 31. The data read by the reading unit 111 is, for example, recognition target data stored in the recognition target data storage unit 314, the specified parameter stored in the parameter storage unit 312, and the dictionary stored in the dictionary storage unit 313.

The data selection unit 212 selects, as feature data to be used for recognition, a number of pieces of feature data equal to the specified number of pieces of data among the recognition target data. At this time, the data selection unit 212 sets a data range having a length corresponding to the specified time width in the recognition target data, and then selects the number of pieces of feature data that is equal to the specified number of pieces of data from the feature data included in the data range. After selecting the specified number of pieces of feature data, the data selection unit 212 can output the selected feature data to another unit (for example, the recognition result derivation unit 213) in the recognition module 21 in a temporally ordered state.

The data selection unit 212 sets a range in which a recognition result is desired to be known as a data range. The setting of the range in which a recognition result is desired to be known may be specified from the outside of the recognition module 21. The recognition module 21 may automatically define the range in which a recognition result is desired to be known. For example, in a case where it is desired to perform recognition in real time, a range including latest feature data may be employed as a range in which a recognition result is desired to be known. In this case, the data selection unit 212 is only required to determine, as the data range, a range from the time of the latest feature data to a time point that is traced back by the length of the specified time width.

Specific examples of the method of selecting the feature data from the determined data range include the selection methods exemplified as the selection method by the data selection unit 112. The data selection unit 212 can select the specified number of pieces of feature data by a method similar to the method performed by the data selection unit 112 (that is, by a selection method similar to the selection method in the training).

The recognition result derivation unit 213 derives the recognition result by inputting the specified number of pieces of feature data selected by the data selection unit 212 to the recognizer based on the dictionary stored in the dictionary storage unit 313. The selected feature data is typically used in a temporally ordered state in the recognition. A specific example of the method of using the feature data includes a use method similar to the use method exemplified in the description of the training unit 114. The recognition result derivation unit 213 can use the selected feature data by a method similar to the method performed by the training unit 114 (that is, by a use method similar to the use method in the training). The recognition result is, for example, information representing a class indicating one behavior output by the recognizer. One aspect of the data indicating the recognition result depends on the recognizer. For example, the recognition result may be represented by a vector in which the number of prepared classes is the number of components, or may be represented by a quantitative value such as a numerical value in the range of “1” to “5”.

The output unit 214 outputs information based on the recognition result derived by the recognition result derivation unit 213. Specifically, output by the output unit 214 is, for example, display on a display, transmission to another information processing device, writing to a storage device, or the like. The method of output by the output unit 214 may be any method as long as information based on the recognition result is transmitted to the outside of the recognition module 21.

The information based on the recognition result may be information directly representing the recognition result or information generated according to the content of the recognition result. For example, the information based on the recognition result may be information indicating behavior of the observation target (“sat on chair”, “raised hand”, “suspicious behavior”, or the like), information indicating a likelihood of each class, a warning message generated according to the recognition result, an instruction according to the recognition result to some device, or the like. The form of the information is not particularly limited, and is only required to be any appropriate form (image data, audio data, text data, command code, voltage, and the like) according to the output destination.

<Operation>

Hereinafter, a flow of operation of the data processing system 1 will be described with reference to the drawings. The operation of the data processing system 1 is divided into an operation of performing training processing by the training module 11 and an operation of performing recognition processing by the recognition module 21. In a case where each processing is executed by a processor that executes a program, each processing in each operation is only required to be executed according to the order of instructions in the program. In a case where each processing is executed by a separate device, it is sufficient if the device that has completed the processing notifies the device that executes the next processing, and thereby the processing is executed in order. Each unit that performs processing is only required to, for example, receive data necessary for the processing from the unit that has generated the data and/or read the data from a storage area included in the module or the storage module 31.

### [Training Processing]

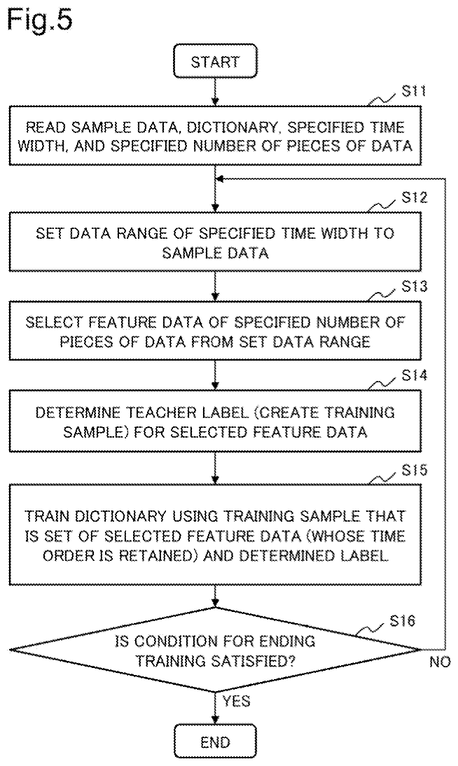

A flow of training processing by the training module 11 will be described with reference to FIG. 5. The training processing is only required to be started, for example, by receiving an instruction to start the training processing from the outside as a trigger.

First, the reading unit 111 reads sample data from the sample data storage unit 311, the dictionary from the dictionary storage unit 313, and the specified time width and the specified number of pieces of data from the parameter storage unit 312 (step S11).

Next, the data selection unit 112 sets the data range of the specified time width to the read sample data (step S12), and selects the specified number of pieces of feature data from the set data range (step S13). The data selection unit 112 may output the selected feature data to another unit in the training module 11 by arranging the feature data in the order of added time.

Next, the label determination unit 113 determines the teacher label for the selected feature data (step S14). A set of the selected feature data (whose time order is retained) and the determined label is the training sample.

Then, the training unit 114 trains the dictionary using the training sample, that is, using the training sample that is a set of the specified number of pieces of selected feature data and whose time order is retained and the determined label (step S15). The training unit 114 may reflect the value of a parameter corrected by the training in the dictionary of the dictionary storage unit 313 every time the correction is performed, or may temporarily record the value in a storage area different from the dictionary storage unit 313 and reflect the value in the dictionary storage unit 313 when the training processing is ended.

After step S15, the training module 11 determines whether a condition for ending the training is satisfied (step S16). As the condition for ending the training, for example, a condition that the number of times of execution of the processing from step S12 to step S15 has reached a predetermined number of times, a condition that an index value indicating the degree of convergence of the parameter value satisfies a predetermined condition, or the like may be employed.

If the condition for ending the training is not satisfied (NO in step S16), the training module 11 performs training again. That is, the training module 11 performs processing from step S12 to step S15. However, the data selection unit 112 selects a feature data group different from the already used feature data group.

The data selection unit 112 may reset the data range. Then, the data selection unit 112 may set the data range by a method in which the data range is shifted every time the setting is performed. For example, the data selection unit 112 may be configured to set the data range such that the start point of the data range is shifted by a predetermined time every time the data range is set.

In a case where the data selection unit 112 is configured to randomly select feature data, the training module 11 may record the feature data group that has already been used so that the same feature data group is not used twice or more in the training. For example, when selecting the feature data group, the data selection unit 112 checks whether any one of the past feature data groups matches the selected feature data group, and when any one thereof matches the selected feature data group, the data selection unit 112 is only required to select a feature data group again.

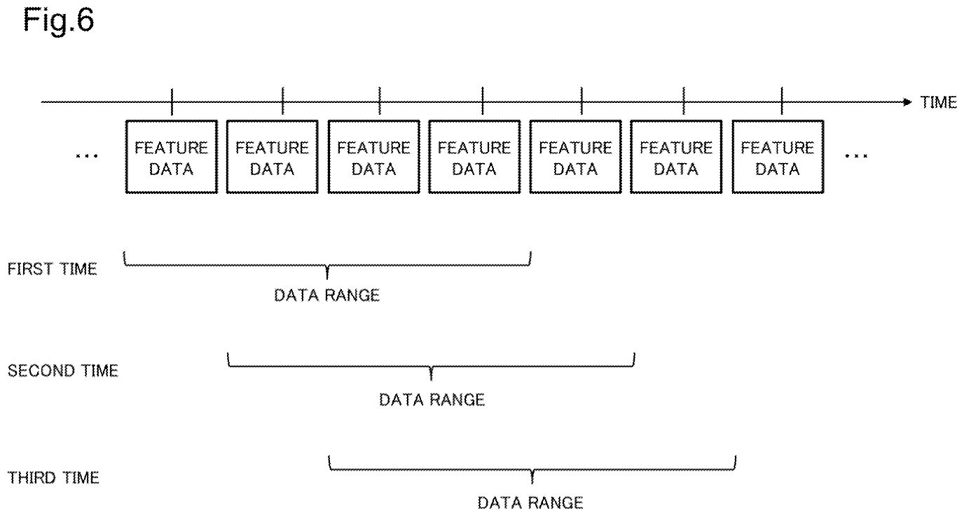

In a case where the data selection unit 112 is configured to select feature data on the basis of the feature data that is the reference (described above), the training module 11 may record the feature data that is the reference, the reference interval (described above), the predetermined number of pieces (already described), or the like that has already been used so that the same feature data group is not used twice or more in the training. Then, every time the processing of step S12 is performed, the data selection unit 112 is only required to set at least any one of the feature data that is the reference, the reference interval, or the predetermined number of pieces to be different from those already used. For example, as illustrated in FIG. 6, the data selection unit 112 may shift the feature data that is the reference every time the processing in step S12 is performed.

If the condition for ending the training is satisfied (YES in step S16), the training module 11 ends the training processing.

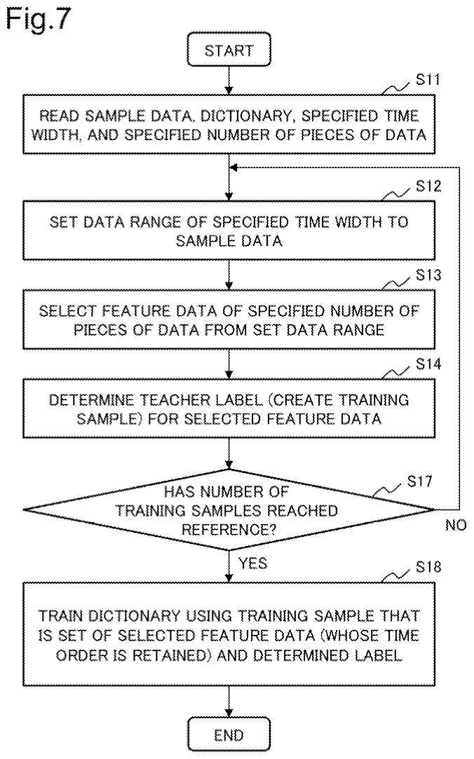

As a modification example of the processing flow described above, the training module 11 may prepare a plurality of training samples and then perform training of the dictionary. That is, the training module 11 may repeat the processing from step S12 to step S14 a predetermined number of times, and then perform the processing of step S15. A flowchart of such an operation flow is illustrated in FIG. 7. On the basis of the flow illustrated in FIG. 7, after the training samples are generated in the process of step S14, the training module 11 determines whether the number of training samples has reached a reference (step S17). It is sufficient if the reference is determined in advance. When the number of training samples does not reach the reference (NO in step S17), the training module 11 performs the processing from step S12 to step S14 again. When the number of training samples reaches the reference (YES in step S17), the training unit 114 trains the dictionary using the plurality of training samples (excluding training samples already used for training) generated between the processing of step S11 and the processing of step S17 (step S18).

### [Recognition Processing]

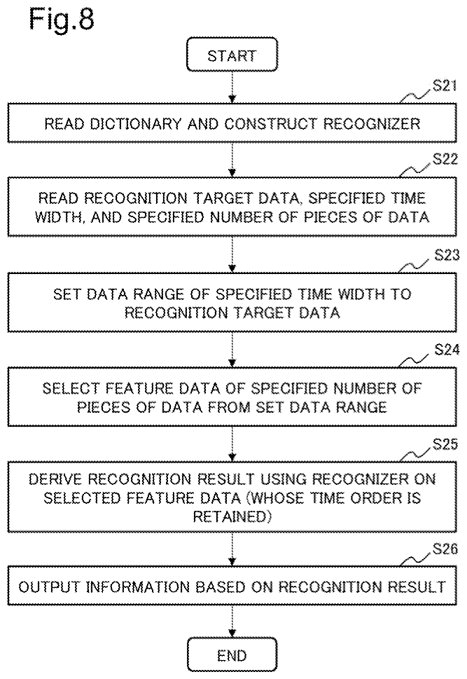

A flow of recognition processing by the recognition module 21 will be described with reference to FIG. 8. It is sufficient if the recognition processing is started by, for example, receiving an instruction to start the recognition processing from the outside as a trigger.

First, the recognition module 21 reads the dictionary from the dictionary storage unit 313, and constructs a recognizer on the basis of the read dictionary (step S21).

Next, the reading unit 211 reads the recognition target data from the recognition target data storage unit 314 and the specified time width and the specified number of pieces of data from the parameter storage unit 312 (step S22).

Next, the data selection unit 212 sets a range in which a recognition result is desired to be known in the recognition target data as a data range of a specified time width (step S23), and selects the specified number of pieces of feature data from the set data range (step S24). The data selection unit 212 may arrange the selected feature data in the order of added time and output the feature data to another unit (for example, recognition result derivation unit 213) in the recognition module 21.

Then, the recognition result derivation unit 213 performs recognition on the selected feature data (whose time order is retained) using the recognizer, and derives a recognition result (step S25).

When the recognition result is derived, the output unit 214 outputs information based on the recognition result (step S26).

<Effects>

By the data processing system 1 according to the first example embodiment, it is possible to generate a recognizer that does not depend on time intervals in the acquisition of time series data.

For example, even when the time intervals of times added to the feature data are different between the sample data and the recognition target data, there is no difference in the used number of pieces of data between the time of training and the time of recognition. The reason is that the specified number of pieces of feature data is selected by the data selection unit 112 and the data selection unit 212 at both the time of training and the time of recognition.

For example, even when the time intervals between pieces of feature data included in the recognition target data are different from those of the sample data or is not constant, the influence thereof on the accuracy of recognition is small. The reason is that, in the training, the data selection unit 112 selects the specified number of pieces of feature data from the data range of the specified time width, thereby constructing a recognizer that does not depend on the time intervals between the pieces of feature data. Although the time intervals are not fixed, since the training sample is used without losing the information of time series relationship, a recognizer capable of outputting various recognition results can be constructed.

That is, the data processing system 1 can perform robust recognition with respect to the time intervals in the acquisition of time series data.

### First Modification Example

The recognition module 21 may derive a plurality of recognition results and output a comprehensive recognition result (described later) on the basis of the plurality of recognition results. For example, the recognition module 21 may repeat the processing from step S23 to step S25 until a predetermined number of recognition results is derived. In that case, in the repetition of the processing, setting of the data range (time when the data range for the recognition target data is set) is not changed.

The modification example as described above is referred to as a first modification example, and details thereof will be described below.

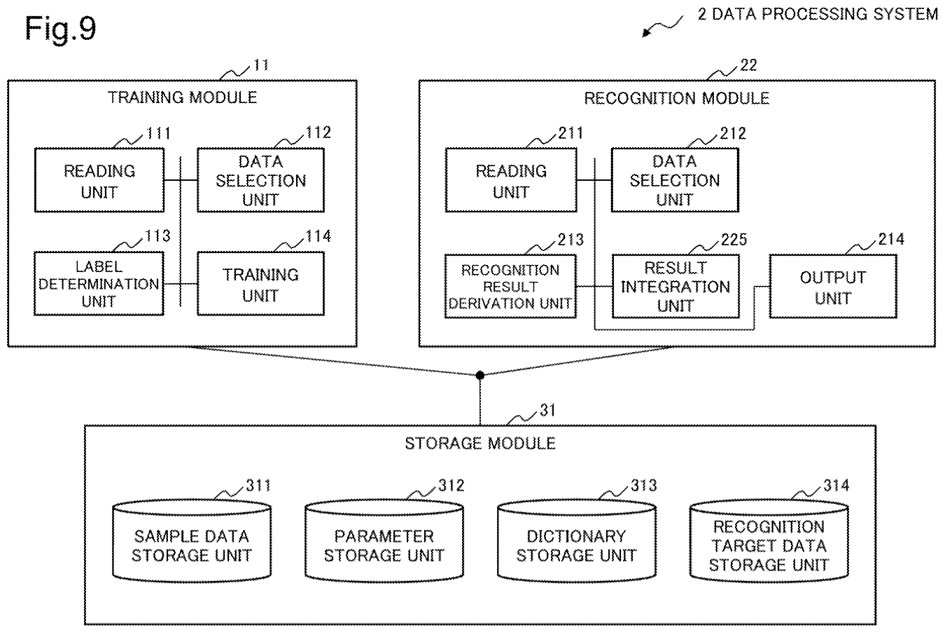

FIG. 9 is a block diagram illustrating a configuration of a data processing system 2 according to the first modification example. The data processing system 2 has a training module 11, a recognition module 22, and a storage module 31. The recognition module 22 includes a result integration unit 225 in addition to the components of the recognition module 21.

In the data processing system 2, the recognition module 22 repeats processing of the data selection unit 212 and processing of the recognition result derivation unit 213 multiple times for data read by the reading unit 211. Accordingly, the recognition module 22 derives a plurality of recognition results. In the repetition of the processing, setting of the data range (time when the data range for the recognition target data is set) is not changed.

The result integration unit 225 integrates a plurality of recognition results derived by the recognition result derivation unit 213. The result integration unit 225 derives a comprehensive recognition result (that is, information indicating one recognition result reflecting a plurality of recognition results) by integrating the recognition results.

A specific example of a method of integration is presented below. For example, the result integration unit 225 may derive a recognition result having the largest number among the plurality of recognition results as a comprehensive recognition result.

In a case where the recognition result is represented by a quantitative value, the result integration unit 225 may calculate a representative value (average value, median value, maximum value, minimum value, or the like) from a plurality of recognition results. The result integration unit 225 may simultaneously calculate a variance. The result integration unit 225 may calculate the representative value after correcting the plurality of recognition results. The correction referred to herein is to correct a value on the basis of a correction amount. As the correction amount, for example, an amount determined on the basis of a temporal relationship of the selected feature data, or the like can be employed.

In a case where the recognition result is represented by identification information of a class and a likelihood, weighted voting using the likelihood as a weight may be performed. The weighted voting is a method of performing cumulative addition of values that increase according to the likelihood and selecting a class having the largest score (that is, the total value) as a result of the addition. In the addition of the values, a value to be added may be set to zero (value not reflected on the score) for a recognition result whose likelihood is less than a predetermined threshold.

In a case where the recognition result is represented by the likelihood for each class, the result integration unit 225 may sum likelihoods indicated by recognition results for each class, and specify a class having the highest total value, which is the summed result, as a comprehensive recognition result.

The output unit 214 outputs information based on the comprehensive recognition result derived by the result integration unit 225. As for specific content of the information based on the comprehensive recognition result, it may be understood that the content described for “the information based on the recognition result” applies as it is. Needless to say, the information based on the comprehensive recognition result is one of the information based on the recognition result derived by the recognition result derivation unit 213.

<Operation>

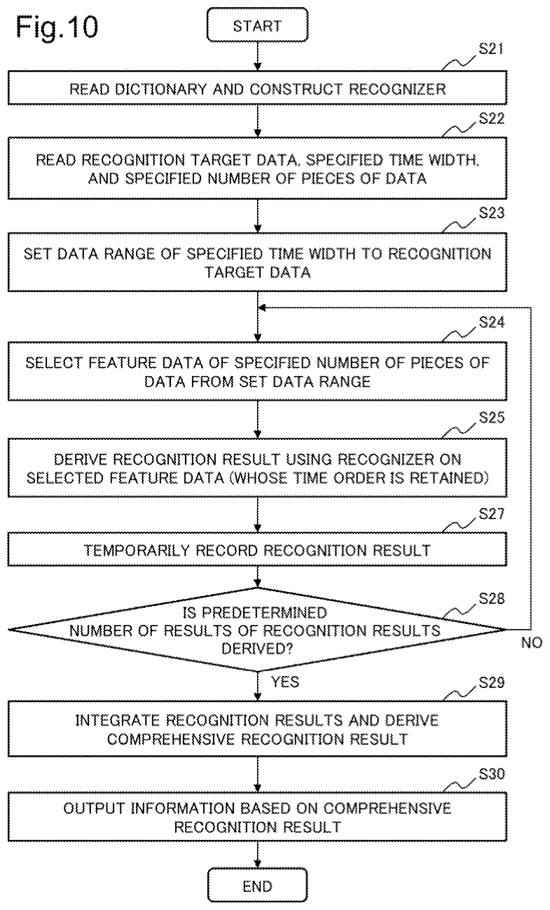

A flow of recognition processing by the recognition module 22 will be described with reference to a flowchart of FIG. 10.

The processing from step S21 to step S25 in FIG. 10 is the same as the processing from step S21 to step S25 by the recognition module 21. After the processing of step S25, the output unit 214 temporarily records the recognition result in the storage area of the storage module 31 (step S27). Then, the recognition module 22 determines whether a predetermined number of results of recognition results has been derived after the start of the processing in step S21 (step S28). In a case where the predetermined number of results of the recognition results have not been derived (NO in step S28), the recognition module 22 performs the processing from step S24 to step S27 again. At this time, the data selection unit 212 does not need to determine the data range again. However, the data selection unit 212 reselects feature data. Various recognition results can be obtained by using different feature data groups in the determined data range.

When the predetermined number of results of the recognition results is derived (YES in step S28), the result integration unit 225 integrates the plurality of temporarily recorded recognition results. As a result, the result integration unit 225 derives a comprehensive recognition result (step S29).

Then, the output unit 214 outputs information based on the comprehensive recognition result (step S30).

The above-described predetermined number of results may be determined in advance, may be specified on the basis of an input from the outside, or may be derived, on the basis of a relationship between the number of pieces of feature data included in the data range and the specified number of pieces of data, by a predetermined calculation equation (for example, a predetermined number of results=int(a X the number of pieces of feature data included in the data range/the specified number of pieces of data) or the like, where int(x) is a function that outputs an integer part of x, and a is a predetermined coefficient). <Effects>

According to the first modification example, it is possible to perform recognition with higher accuracy. The reason is that the recognition result is comprehensively derived not only from one set of feature data groups but also from a plurality of feature data groups based on the same specified time width. That is, the recognition module 22 more effectively uses the feature data included in the data range determined by the data selection unit 212 in the recognition. Therefore, accuracy and reliability of recognition are improved.

### Second Modification Example

Hereinafter, a second modification example of the first example embodiment will be described. In the second modification example, recognition using a plurality of dictionaries is performed.

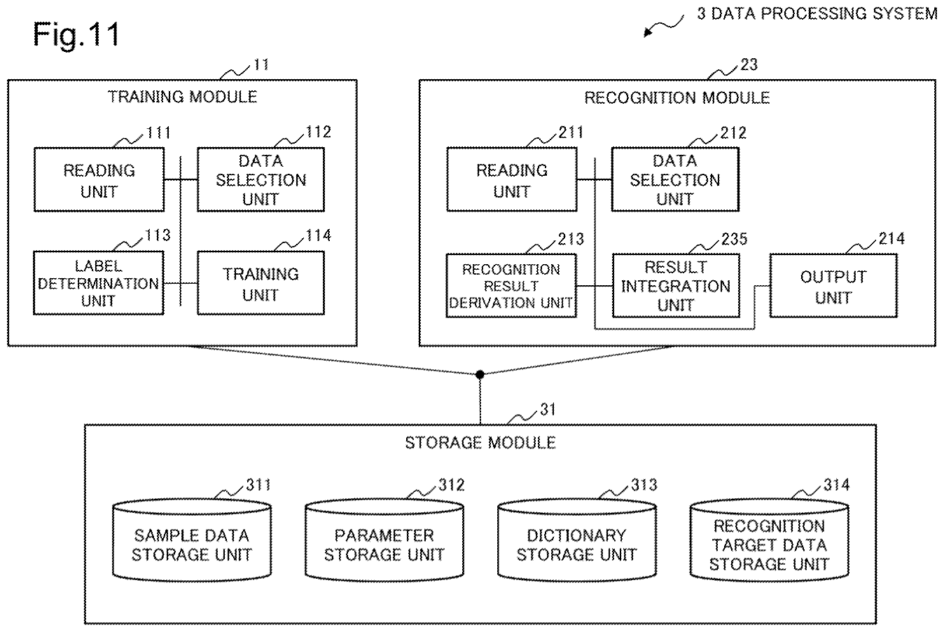

FIG. 11 is a block diagram illustrating a configuration of a data processing system 3 according to the second modification example. The data processing system 3 has a training module 11, a recognition module 23, and a storage module 31. The recognition module 23 includes a result integration unit 235 in addition to the components of the recognition module 21.

In the data processing system 3, the dictionary storage unit 313 of the storage module 31 stores a plurality of dictionaries.

In the data processing system 3, the training module 11 performs the training of dictionary for each of the dictionaries. The method of training each dictionary may be similar to the method described in the first example embodiment.

However, the specified time width used when selecting the feature data to be used for the training is different for each dictionary. That is, the training module 11 performs the training on the plurality of dictionaries using different specified time widths. The specified number of pieces of data may be the same among all the dictionaries or may be different for each dictionary. It is sufficient if the parameter storage unit 312 stores a plurality of different specified time widths and the specified numbers of pieces of data related to the plurality of specified time widths for each of the dictionaries, and the reading unit 111 reads the to stored specified time width and specified number of pieces of data related to the dictionary for each training of the dictionary.

The recognition module 23 derives each recognition result using each of the plurality of dictionaries. That is, a plurality of recognition results derived on the basis of different dictionaries (that is, dictionaries related to different specified time widths) is obtained for certain recognition target data. The recognition module 23 repeats selection of a dictionary and recognition processing using the dictionary, for example, by the number of dictionaries.

In each recognition process, the recognition module 23 selects a dictionary, reads the specified time width and the specified number of pieces of data used for training the selected dictionary, and performs recognition processing using the read specified time width and specified number of pieces of data. For this purpose, for example, it is sufficient if data associating the dictionary with the specified time width and the specified number of pieces of data used for training the dictionary are stored in the storage module 31.

The result integration unit 235 integrates a plurality of recognition results derived by the recognition result derivation unit 213. The result integration unit 235 derives a final recognition result (that is, information to be output as a result of recognition by the recognition module 23) by integrating the recognition results.

The method of integration by the result integration unit 235 may be the same as any of the methods described as a method of integration by the result integration unit 225 of the first modification example.

The output unit 214 outputs information based on the final recognition result derived by the result integration unit 235. As for specific content of the information based on the final recognition result, it may be understood that the content described for “the information based on the recognition result” applies as it is. Needless to say, the information based on the final recognition result is one of the information based on the recognition result derived by the recognition result derivation unit 213.

<Operation>

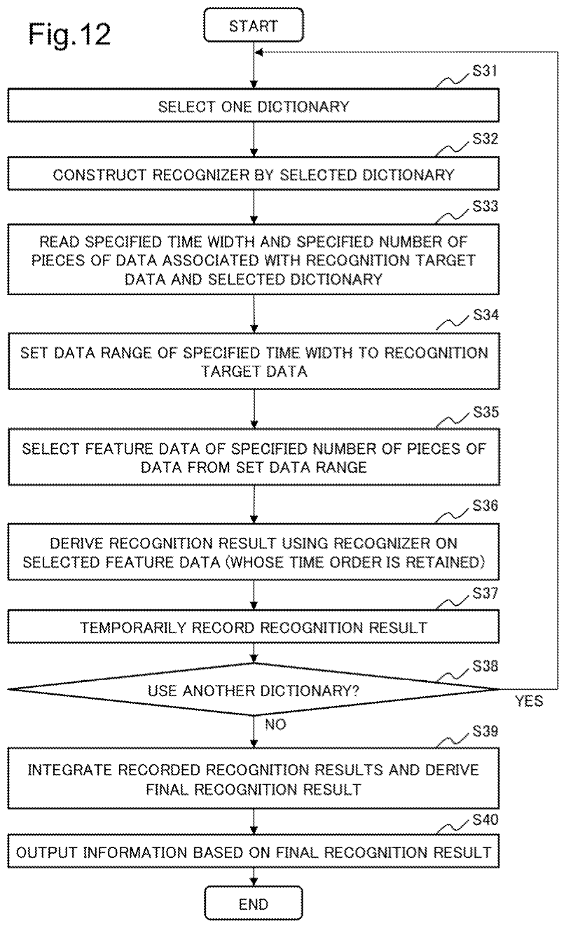

A flow of recognition processing by the recognition module 23 will be described with reference to a flowchart of FIG. 12.

First, the recognition module 23 selects one dictionary from the plurality of dictionaries (step S31). Then, the recognition module 23 constructs a recognizer with the selected dictionary (step S32).

Next, the reading unit 211 reads the recognition target data, the specified time width associated with the selected dictionary, and the specified number of pieces of data (step S33). Then, the data selection unit 212 sets a range in which a recognition result is desired to be known in the recognition target data as the data range of the specified time width (step S34), and selects the specified number of pieces of feature data from the set data range (step S35). The data selection unit 212 arranges and outputs the selected data in the order of added time. Then, the recognition result derivation unit 213 derives a recognition result using the recognizer for the selected feature data (whose time order is retained) (step S36).

When the recognition result is derived, the output unit 214 temporarily records the recognition result (for example, in the storage area of the storage module 31) (step S37).

Next, the recognition module 23 determines whether to use another dictionary (step S38). The criterion for this determination may be, for example, whether use of all the dictionaries stored in the dictionary storage unit 313 has been finished, whether the number of obtained recognition results has reached a predetermined number, or the like.

When another dictionary is used (YES in step S38), the recognition module 23 performs the processing from step S31 again. However, the dictionary selected in step S31 is a dictionary other than the already-selected dictionary.

When another dictionary is not used (NO in step S38), the result integration unit 235 integrates a plurality of temporarily recorded recognition results, thereby deriving a final recognition result (step S39).

Then, the output unit 214 outputs information based on the final recognition result (step S40).

In step S32, the recognition module 23 constructs the recognizer with the selected dictionary every time the dictionary is selected, but recognizers with all the dictionaries may be constructed in advance. In this case, step S32 is omitted, and in step S36, the recognition result derivation unit 213 selects and uses a recognizer that matches the selected dictionary from the recognizers constructed in advance.

<Effects>

According to the second modification example, it is possible to perform recognition with higher accuracy. The reason is that the plurality of dictionaries each trained using the plurality of specified time widths is used for recognition, and a final recognition result is integrally derived from a plurality of recognition results by the result integration unit 235.

### Change Example

Hereinafter, some change examples of the matters described in the above description of the example embodiment will be described.

(1)

In the sample data, a plurality of labels may be added to one piece of feature data.

(2)

The label in the sample data is not necessarily applied to all feature data.

(3)

In the sample data, the label may be added to the time range instead of the feature data. In such a case, the label determination unit 113 is only required to determine the teacher label on the basis of one or more labels added to the time range including the time added to the selected feature data. Alternatively, the label determination unit 113 may determine the teacher label on the basis of the relationship between the data range determined by the data selection unit 112 and the time range to which the label is given. For example, in a case where the length of a time range, to which a certain label “A” is given, included in the data range determined by the data selection unit 112 is longer than the length of a time range, to which any other label is given, included in the data range determined by the data selection unit 112, the label determination unit 113 may determine the label “A” as the teacher label.

(4)

The recognition by the recognition module 21 to 23 may be recognition other than occurrence of a behavior or an event. The recognition may be recognition other than the exemplified recognition as long as the recognition uses a plurality of pieces of feature data arranged in time series.

(5)

The label may be information indicating a state of the observation target. Examples of the label indicating the state include “present”, “not present”, “moving”, “falling”, “rotating”, “having an object”, “looking left”, “fast”, “slow”, “normal”, “abnormal”, and the like.

(6)

The label determination unit 113 may determine the teacher label on the basis of a combination of labels added to each data. For example, in a case where the extracted label includes two types of labels of “moving” and “stopped” in time order, the label determination unit 113 can determine the label of “started to stay” as the teacher label. For example, in a case where there are two types of labels of “looking left” and “looking right” among extracted labels, the label determination unit 113 can determine a label of “looking around” as the teacher label.

### Second Example Embodiment

A recognizer training device and a recognition device according to one example embodiment of the present invention will be described.

A recognizer training device 10 according to the one example embodiment of the present invention is a device that trains a recognizer that outputs a recognition result using a time series of feature data as an input.

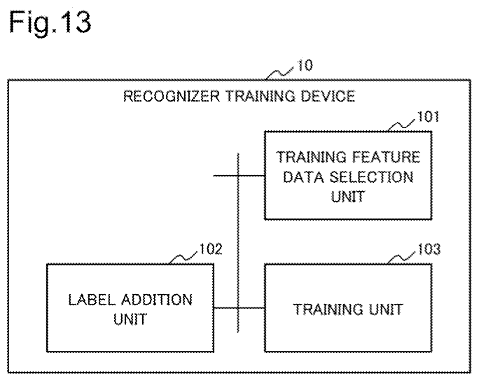

FIG. 13 is a block diagram illustrating a configuration of the recognizer training device 10. The recognizer training device 10 includes a training feature data selection unit 101, a label addition unit 102, and a training unit 103.

The training feature data selection unit 101 sets a data range whose length is a specified time width to a set of feature data to which a time and label are added, and selects a specified number of pieces of the feature data from within the set data range. The data selection unit 112 in the first example embodiment corresponds to an example of the training feature data selection unit 101.

The label addition unit 102 adds a teacher label corresponding to the recognition result of the recognizer to a plurality of (specified number of) pieces of feature data, which is selected by the training feature data selection unit 101 and whose time order is retained, on the basis of information regarding the plurality of pieces of feature data. An example of the information regarding the plurality of pieces of feature data is a label added to at least one of the plurality of pieces of feature data. The label determination unit 113 in the first example embodiment corresponds to an example of the label addition unit 102.

The training unit 103 trains the recognizer by using, as training data, a set of the plurality of pieces of feature data, which is selected by the training feature data selection unit 101 and whose time order is retained, and the teacher label added by the label addition unit 102. The training unit 114 in the first example embodiment corresponds to an example of the training unit 103.

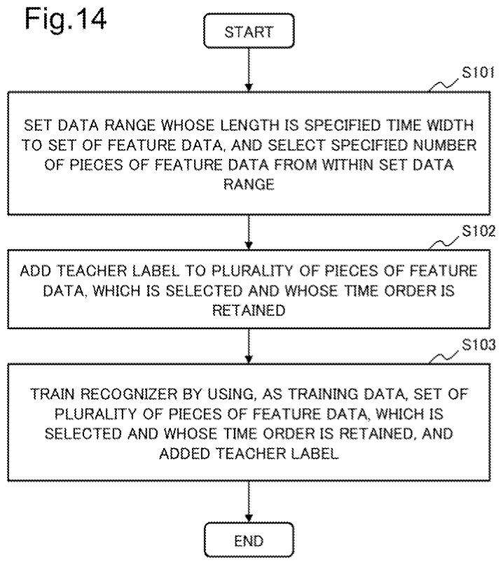

A flow of operation by the recognizer training device 10 will be described with reference to a flowchart of FIG. 14. First, the training feature data selection unit 101 sets a data range whose length is a specified time width to a set of feature data, and selects a specified number of pieces of feature data from within the set data range (step S101). Next, the label addition unit 102 adds a teacher label corresponding to the recognition result of the recognizer to a plurality of pieces of feature data, which is selected by the training feature data selection unit 101 and whose time order is retained, on the basis of information regarding the plurality of pieces of feature data (step S102). Then, the training unit 103 trains the recognizer by using, as training data, a set of a plurality of pieces of feature data, which is selected by the training feature data selection unit 101 and whose time order is retained, and a teacher label added by the label addition unit 102 (step S103).

With the recognizer training device 10, it is possible to generate a recognizer that does not depend on time intervals in acquisition of time series data. The reason is that the training feature data selection unit 101 can select feature data without depending on the time intervals, and the training unit 103 trains the recognizer using the selected feature data.

A recognition device 20 according to the one example embodiment of the present invention performs recognition using a recognizer with a plurality of pieces of feature data as inputs. It is effective to employ the recognizer trained by the above-described recognizer training device 10 as the recognizer used by the recognition device 20.

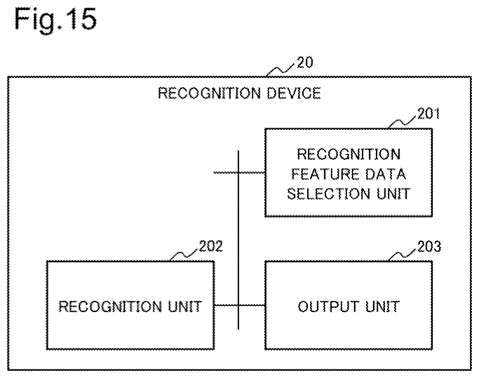

FIG. 15 is a block diagram illustrating a configuration of the recognition device 20. The recognition device 20 includes a recognition feature data selection unit 201, a recognition unit 202, and an output unit 203.

The recognition feature data selection unit 201 sets a data range whose length is a specified time width, as a range in which a recognition result is desired to be known, to a set of feature data to which a time is added, and selects a specified number of pieces of feature data from within the set data range. The data selection unit 212 in the first example embodiment corresponds to an example of the recognition feature data selection unit 201.

The recognition unit 202 derives a recognition result by inputting, to the recognizer, a plurality of (a specified number of) pieces of feature data, which is selected by the recognition feature data selection unit 201 and whose time order is retained. The recognition result derivation unit 213 according to the first example embodiment corresponds to an example of the recognition unit 202.

The output unit 203 outputs information based on the recognition result derived by the recognition unit 202. The output unit 214 in the first example embodiment corresponds to an example of the output unit 203.

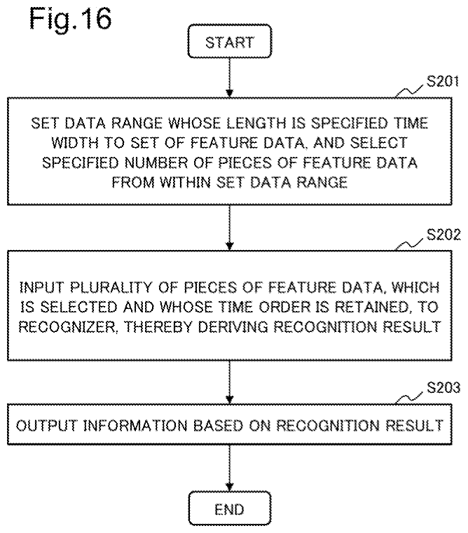

A flow of operation by the recognition device 20 will be described with reference to a flowchart of FIG. 16. First, the recognition feature data selection unit 201 sets a data range whose length is a specified time width, as a range in which a recognition result is desired to be known, to a set of feature data to which a time is added, and selects a specified number of pieces of feature data from within the set data range (step S201). Next, the recognition unit 202 inputs a plurality of pieces of feature data, which is selected by the recognition feature data selection unit 201 and whose time order is retained, to the recognizer, thereby deriving a recognition result (step S202). Then, the output unit 203 outputs information based on the recognition result derived by the recognition unit 202 (step S203).

With the recognition device 20, it is possible to perform recognition that does not depend on time intervals in acquisition of time series data. The reason is that the recognition feature data selection unit 201 can select the feature data without depending on the time intervals, and the recognition unit 202 performs the recognition using the selected plurality of pieces of feature data.

<Configuration of Hardware for Achieving Each Unit of Example Embodiment>

In each example embodiment of the present invention described above, blocks indicating components of each device are described in functional units. However, the block indicating a component does not necessarily mean that each component is constituted by a separate module.

The processing of each component may be achieved by, for example, a computer system reading and executing a program that is stored in a computer-readable storage medium and causes the computer system to execute the processing. The “computer-readable storage medium” is, for example, a portable medium such as an optical disk, a magnetic disk, a magneto-optical disk, and a nonvolatile semiconductor memory, and a storage device such as a read only memory (ROM) and a hard disk built in a computer system. The “computer-readable storage medium” includes a medium that can temporarily hold a program like a volatile memory inside a computer system, and a medium that transmits a program like a communication line such as a network or a telephone line. The program may be for achieving a part of the functions described above, and may be capable of achieving the functions described above in combination with a program already stored in the computer system.

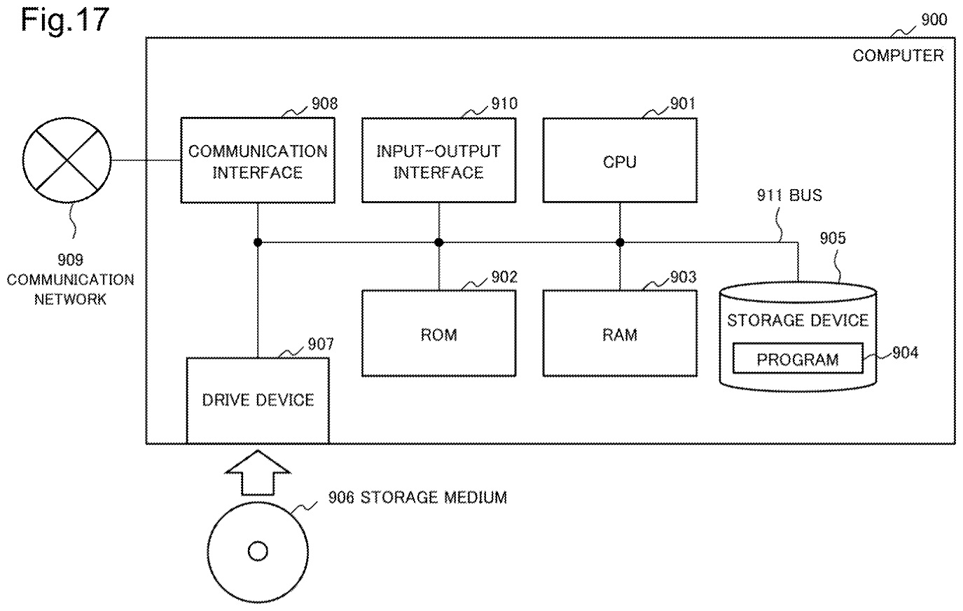

The “computer system” is a system including a computer 900 as illustrated in FIG. 17 as an example. The computer 900 includes the following configuration.
one or more central processing units (CPUs) 901
a ROM 902
a random access memory (RAM) 903
a program 904 loaded into the RAM 903
a storage device 905 storing the program 904
a drive device 907 that reads from and writes to a storage medium 906
a communication interface 908 connected to a communication network 909
an input-output interface 910 for inputting and outputting data
a bus 911 connecting components

For example, each component of each device in each example embodiment is achieved by the CPU 901 loading the program 904 for achieving the function of the component into the RAM 903 and executing the program 904. The program 904 for achieving the function of each component of each device is stored in the storage device 905 or the ROM 902 in advance, for example. The CPU 901 reads the program 904 as necessary. The storage device 905 is, for example, a hard disk. The program 904 may be supplied to the CPU 901 via a communication network 909, or may be stored in the storage medium 906 in advance, read by the drive device 907, and supplied to the CPU 901. The storage medium 906 is, for example, a portable medium such as an optical disk, a magnetic disk, a magneto-optical disk, and a nonvolatile semiconductor memory.

There are various modification examples of a method of achieving each device. For example, each device may be achieved by a possible combination of the individual computer 900 and program separate for each component. A plurality of components included in each device may be achieved by a possible combination of one computer 900 and a program.

Some or all of each component of each device may be achieved by another general-purpose or dedicated circuit, computer, or the like, or a combination thereof. These components may be configured by a single chip or may be configured by a plurality of chips connected via a bus.

In a case where some or all of each component of each device are achieved by a plurality of computers, circuits, and the like, the plurality of computers, circuits, and the like may be arranged in a centralized manner or in a distributed manner. For example, the computer, the circuit, and the like may be achieved as a form in which each is connected via a communication network, such as a client and server system or a cloud computing system.

The whole or part of the example embodiments disclosed above can be described as, but not limited to, the following supplementary notes.

<<Supplementary Note>>

### [Supplementary Note 1]

A recognizer training device that trains a recognizer that outputs a recognition result by using a time series of feature data as an input, the recognizer training device comprising: a training feature data selection means for setting a data range whose length is a specified time width to a set of feature data to which a time is added, and selecting a specified number of pieces of the feature data from within the data range;

a label addition means for adding a teacher label corresponding to the recognition result to a plurality of pieces of feature data, which is selected by the training feature data selection means and whose time order is retained, based on information regarding the plurality of pieces of feature data; and

a training means for training the recognizer by using, as training data, a set of the plurality of pieces of feature data, whose time order is retained, and the teacher label added by the label addition means.

### [Supplementary Note 2]

The recognizer training device according to supplementary note 1, in which the training feature data selection means sets the data range by a method of randomly setting a data range or a method of setting a data range by shifting in each setting.

### [Supplementary Note 3]

The recognizer training device according to supplementary note 1 or 2, in which

a label corresponding to the recognition result is added to each piece of the feature data included in the set, and

the label addition means

extracts, from each of the plurality of pieces of feature data selected by the training feature data selection means, the label associated with the feature data, and

selects a label by using any one of a method of selecting a label with a largest number of labels among the extracted labels or a method of enumerating the number of labels with a weight based on time being set to each of the extracted labels and selecting a label with a largest total value as a result of the enumeration, and determines the selected label as the teacher label.

### [Supplementary Note 4]

The recognizer training device according to any one of supplementary notes 1 to 3, in which the training feature data selection means selects the specified number of pieces of the feature data by a method of performing random selection without duplication.

### [Supplementary Note 5]

The recognizer training device according to any one of supplementary notes 1 to 4, in which when selecting the specified number of pieces of the feature data from the data range, the training feature data selection means selects the specified number of pieces of the feature data in such a way as to include feature data to which a latest time is added among the feature data in the data range.

### [Supplementary Note 6]

The recognizer training device according to any one of supplementary notes 1 to 4, in which the training feature data selection means sets a larger weight for feature data to which a newer time is added in the data range, and selects the specified number of pieces of the feature data by a weighted random selection method.

### [Supplementary Note 7]

The recognizer training device according to any one of supplementary notes 1 to 6, in which

each of the plurality of pieces of feature data whose time order is retained is represented by a vector, and

the training means uses, as data on an input side of the training data, one vector generated by connecting a plurality of pieces of the feature data selected by the training feature data selection means in order of the time.

### [Supplementary Note 8]

The recognizer training device according to any one of supplementary notes 1 to 6, in which

each of the plurality of pieces of feature data whose time order is retained is represented by a value arranged two-dimensionally, and the recognizer is a neural network, and

the training means uses, as data on an input side of the training data, three-dimensional data generated by arranging a plurality of pieces of the feature data selected by the training feature data selection means in order of the time.

### [Supplementary Note 9]

A recognition device comprising:

a recognition feature data selection means for setting a data range whose length is a specified time width to a set of feature data to which a time is added, and selecting a specified number of pieces of the feature data from within the data range;

a recognition means for deriving a recognition result by inputting, to a recognizer, a plurality of pieces of feature data, which is selected by the recognition feature data selection means and whose time order is retained; and

an output means for outputting information based on the recognition result.

### [Supplementary Note 10]

The recognition device according to supplementary note 9, in which the recognition feature data selection means sets the data range in such a way as to include feature data to which a latest time is added among the set of feature data.

### [Supplementary Note 11]

The recognition device according to supplementary note 9 or 10, in which the recognition feature data selection means selects the specified number of pieces of the feature data by a method of performing random selection without duplication.

### [Supplementary Note 12]

The recognition device according to any one of supplementary notes 9 to 11, in which when selecting the specified number of pieces of the feature data from the data range, the recognition feature data selection means selects the specified number of pieces of the feature data in such a way as to include feature data to which a latest time is added among the feature data in the data range.

### [Supplementary Note 13]

The recognition device according to any one of supplementary notes 9 to 11, in which the recognition feature data selection means sets a larger weight for feature data to which a newer time is added in the data range, and selects the specified number of pieces of the feature data by a weighted random selection method.

### [Supplementary Note 14]

The recognition device according to any one of supplementary notes 9 to 13, in which

a plurality of recognition results is acquired by executing processing of the recognition feature data selection means and processing of the recognition means a predetermined number of times under setting of the data range that is fixed, and

the recognition device further comprises a recognition result integration means for deriving a comprehensive recognition result by integrating the plurality of recognition results.

### [Supplementary Note 15]

The recognition device according to any one of supplementary notes 9 to 13, in which

the recognition result for each time width is acquired by executing processing of the recognition feature data selection means and processing of the recognition means for each of a plurality of different specified time widths, and

the recognition device further comprises a recognition result integration means for deriving a final recognition result by integrating the recognition results for each of the time widths.

### [Supplementary Note 16]

A data processing system comprising:

the recognizer training device according to any one of supplementary notes 1 to 8; and

the recognition device according to any one of supplementary notes 9 to 15.

### [Supplementary Note 17]

A data processing method for training a recognizer that outputs a recognition result by using a time series of feature data as an input, the data processing method comprising:

setting a data range whose length is a specified time width to a set of feature data to which a time is added, and selecting a specified number of pieces of the feature data from within the data range;

adding a teacher label corresponding to the recognition result to the selected plurality of pieces of feature data, whose time order is retained, based on information regarding the plurality of pieces of feature data; and

training the recognizer by using, as training data, a set of the plurality of pieces of feature data, whose time order is retained, and the teacher label.

### [Supplementary Note 18]

A data processing method comprising:

setting a data range whose length is a specified time width to a set of feature data to which a time is added, and selecting a specified number of pieces of the feature data from within the data range;

deriving a recognition result by inputting, to a recognizer, the selected plurality of pieces of feature data, whose time order is retained; and

outputting information based on the recognition result.

### [Supplementary Note 19]

The data processing method according to supplementary note 17 or 18, in which the training feature data selection means sets the data range by a method of randomly setting a data range or a method of setting a data range by shifting in each setting.

### [Supplementary Note 20]

The data processing method according to supplementary note 17, in which

a label corresponding to the recognition result is added to each piece of the feature data included in the set,

the label associated with the each piece of the feature data is extracted from each of the plurality of pieces of feature data, and

a label is selected by using any one of a method of selecting a label with a largest number of labels among the extracted labels or a method of enumerating the number of labels with a weight based on time being set to each of the extracted labels and selecting a label with a largest total value as a result of the enumeration, and the selected label is determined as the teacher label.

### [Supplementary Note 21]

The data processing method according to any one of supplementary notes 17 to 20, in which the specified number of pieces of the feature data is selected by a method of performing random selection without duplication.

### [Supplementary Note 22]

The data processing method according to any one of supplementary notes 17 to 20, in which when selecting the specified number of pieces of the feature data from the data range, the specified number of pieces of the feature data is selected in such a way as to include feature data to which a latest time is added among the feature data in the data range.

### [Supplementary Note 23]

The data processing method according to any one of supplementary notes 17 to 20, in which a larger weight is set for feature data to which a newer time is added in the data range, and the specified number of pieces of the feature data is selected by a weighted random selection method.

### [Supplementary Note 24]

The data processing method according to any one of supplementary notes 17 to 23, in which

each of the plurality of pieces of feature data whose time order is retained is represented by a vector, and

one vector generated by connecting the selected plurality of pieces of the feature data in order of the time is used as data to be input to the recognizer.

### [Supplementary Note 25]

The data processing method according to any one of supplementary notes 17 to 23, in which

each of the plurality of pieces of feature data whose time order is retained is represented by a value arranged two-dimensionally, and the recognizer is a neural network, and

three-dimensional data generated by arranging the selected plurality of pieces of the feature data in order of the time is used as data to be input to the recognizer.

### [Supplementary Note 26]

The data processing method according to supplementary note 18, in which

a plurality of recognition results is acquired by executing the selecting the specified number of pieces of the feature data and the deriving the recognition result a predetermined number of times under setting of the data range that is fixed,

a comprehensive recognition result is derived by integrating the plurality of recognition results, and

outputting information based on the comprehensive recognition result.

### [Supplementary Note 27]

The data processing method according to supplementary note 18 or 26, in which

the recognition result for each time width is acquired by executing the selecting the specified number of pieces of the feature data and deriving the recognition result for each of a plurality of different specified time widths,

a final recognition result is derived by integrating the recognition results for each of the time widths, and

outputting information based on the final recognition result.

### [Supplementary Note 28]

A computer-readable storage medium recording a program for training a recognizer that outputs a recognition result by using a time series of feature data as an input, the program causing a computer to execute:

feature data selection processing of setting a data range whose length is a specified time width to a set of feature data to which a time is added, and selecting a specified number of pieces of the feature data from within the data range;

label addition processing of adding a teacher label corresponding to the recognition result to a plurality of pieces of feature data, which is selected by the feature data selection processing and whose time order is retained, based on information regarding the plurality of pieces of feature data; and

training processing of training the recognizer by using, as training data, a set of the plurality of pieces of feature data, whose time order is retained, and the teacher label added by the label addition processing.

### [Supplementary Note 29]

A computer-readable storage medium recording a program for causing a computer to execute:

feature data selection processing of setting a data range whose length is a specified time width to a set of feature data to which a time is added, and selecting a specified number of pieces of the feature data from within the data range;

recognition processing of deriving a recognition result by inputting, to a recognizer, a plurality of pieces of feature data, which is selected by the feature data selection processing and whose time order is retained; and

output processing of outputting information based on the recognition result.

### [Supplementary Note 30]

The storage medium according to supplementary note 28 or 29, in which the feature data selection processing sets the data range by a method of randomly setting a data range or a method of setting a data range by shifting in each setting.

### [Supplementary Note 31]

The storage medium according to supplementary note 28, in which

a label corresponding to the recognition result is added to each piece of the feature data included in the set, and

the label addition processing

extracts, from each piece of the feature data selected by the feature data selection processing, the label associated with the each piece of the feature data, and

selects a label by using either a method of selecting a label with a largest number of labels among the extracted labels or a method of enumerating the number of labels with a weight based on time being set to each of the extracted labels and selecting a label with a largest total value as a result of the enumeration, and determines the selected label as the teacher label.

### [Supplementary Note 32]

The storage medium according to any one of supplementary notes 28 to 31, in which the feature data selection processing selects the specified number of pieces of the feature data by a method of performing random selection without duplication.

### [Supplementary Note 33]

The storage medium according to any one of supplementary notes 28 to 31, in which when selecting the specified number of pieces of the feature data from the data range, the feature data selection processing selects the specified number of pieces of the feature data in such a way as to include feature data to which a latest time is added among the feature data in the data range.

### [Supplementary Note 34]

The storage medium according to any one of supplementary notes 28 to 31, in which the feature data selection processing sets a larger weight for feature data to which a newer time is added in the data range, and selects the specified number of pieces of the feature data by a weighted random selection method.

### [Supplementary Note 35]

The storage medium according to any one of supplementary notes 28 to 34, in which

each of the plurality of pieces of feature data whose time order is retained is represented by a vector, and

the program causes the computer to use one vector generated by connecting a plurality of pieces of the feature data selected by the feature data selection processing in order of the time as data to be input to the recognizer.

### [Supplementary Note 36]

The storage medium according to any one of supplementary notes 28 to 34, in which

each of the plurality of pieces of feature data whose time order is retained is represented by a value arranged two-dimensionally, and the recognizer is a neural network, and

the program causes the computer to use, as data to be input to the recognizer, three-dimensional data generated by arranging a plurality of pieces of the feature data selected by the feature data selection processing in order of the time.

### [Supplementary Note 37]

The storage medium according to supplementary note 29, in which

the program causes

the computer to acquire a plurality of recognition results by executing the feature data selection processing and the recognition processing a predetermined number of times under setting of the data range that is fixed, and

the computer to execute recognition result integration processing of deriving a comprehensive recognition result by integrating the plurality of recognition results.

### [Supplementary Note 38]

The storage medium according to supplementary note 29 or 37, in which

the program causes

the computer to execute the feature data selection processing and the recognition processing for each of a plurality of different specified time widths in such a way as to acquire the recognition result for each time width, and

the computer to execute integration processing of deriving a final recognition result by integrating the recognition results for each of the time widths.

The invention is not limited to the exemplary embodiments thereof described above. It will be understood by those of ordinary skill in the art that various changes in form and details described above may be made therein without departing from the spirit and scope of the present invention as defined by the claims.

### REFERENCE SIGNS LIST

1, 2, 3 Data processing system
1 Recognizer training device
101 Training feature data selection unit
102 Label addition unit
103 Training unit
20 Recognition device
201 Recognition feature data selection unit
202 Recognition unit
203 Output unit
11 Training module
111 Reading unit
112 Data selection unit
113 Label determination unit
114 Training unit
21, 22, 23 Recognition module
211 Reading unit
212 Data selection unit
213 Recognition result derivation unit
214 Output unit
225 Result integration unit
235 Result integration unit
31 Storage module
311 Sample data storage unit
312 Parameter storage unit
313 Dictionary storage unit
314 Recognition target data storage unit

### 900 Computer

### 901 CPU

### 902 ROM

### 903 RAM

### 904 Program

905 Storage device
906 Storage medium
907 Drive device
908 Communication interface
909 Communication network
910 Input-output interface

### 911 Bus

What is claimed is:

1. A recognizer training device that trains a recognizer that outputs a recognition result by using a time series of feature data as an input, the recognizer training device comprising: comprising one or more memories storing instructions and one or more processors configured to execute the instructions to:
set a data range whose length is a specified time width to a set of feature data to which a time is added, and select a specified number of pieces of the feature data from within the data range;
add a teacher label corresponding to the recognition result to a selected plurality of pieces of feature data, whose time is retained, based on information regarding the plurality of pieces of feature data; and
train the recognizer by using, as training data, a set of the plurality of pieces of feature data, whose time order is retained, and the added teacher label.

2. The recognizer training device according to claim 1, wherein the one or more processors are configured to execute the instructions to set the data range by a method of randomly setting a data range or a method of setting a data range by shifting in each setting.

3. The recognizer training device according to claim 1
wherein a label corresponding to the recognition result is added to each piece of the feature data included in the set, and
wherein the one or more processors are configured to execute the instructions to:
extract, from each of the selected plurality of pieces of feature data, the label associated with the feature data, and
select a label by using either a method of selecting a label with a largest number of labels among the extracted labels or a method of enumerating the number of labels with a weight based on time being set to each of the extracted labels and selecting a label with a largest total value as a result of the enumeration, and determines determine the selected label as the teacher label.

4. The recognizer training device according to claim 1, wherein the one or more processors are configured to execute the instructions to select the specified number of pieces of the feature data by a method of performing random selection without duplication.

5. The recognizer training device according to claim 1 wherein when selecting the specified number of pieces of the feature data from the data range, the one or more processors are configured to execute the instructions to select the specified number of pieces of the feature data in such a way as to include feature data to which a latest time is added among the feature data in the data range.

6. The recognizer training device according to claim 1, wherein the one or more processors are configured to execute the instructions to set a larger weight for feature data to which a newer time is added in the data range, and select the specified number of pieces of the feature data by a weighted random selection method.

7. The recognizer training device according to claim 1,
wherein each of the plurality of pieces of feature data whose time order is retained is represented by a vector, and
wherein the one or more processors are configured to execute the instructions to use, as data on an input side of the training data, one vector generated by connecting a selected plurality of pieces of the feature data in order of the time.

8. The recognizer training device according to claim 1,
wherein each of the plurality of pieces of feature data whose time order is retained is represented by a value arranged two-dimensionally, and the recognizer is a neural network, and
wherein the one or more processors are configured to execute the instructions to use, as data on an input side of the training data, three-dimensional data generated by arranging a selected plurality of pieces of the feature data in order of the time.

9. A recognition device comprising one or more memories storing instructions and one or more processors configured to execute the instructions to:
set a data range whose length is a specified time width to a set of feature data to which a time is added, and select a specified number of pieces of the feature data from within the data range;
derive a recognition result by inputting, to a recognizer, a selected plurality of pieces of feature data, whose time order is retained; and
output information based on the recognition result.

10. The recognition device according to claim 9, wherein the one or more processors are configured to execute the instructions to set the data range in such a way as to include feature data to which a latest time is added among the set of feature data.

11. The recognition device according to claim 9, wherein the one or more processors are configured to execute the instructions to select the specified number of pieces of the feature data by a method of performing random selection without duplication.

12. The recognition device according to claim 9, wherein when selecting the specified number of pieces of the feature data from the data range, the one or more processors are configured to execute the instructions to select the specified number of pieces of the feature data in such a way as to include feature data to which a latest time is added among the feature data in the data range.

13. The recognition device according to claim 9, wherein the one or more processors are configured to execute the instructions to set a larger weight for feature data to which a newer time is added in the data range, and select the specified number of pieces of the feature data by a weighted random selection method.

14. The recognition device according to claim 9,
wherein a plurality of recognition results is acquired by executing the selecting the specified number of pieces of the feature data and the deriving the recognition result a predetermined number of times under setting of the data range that is fixed, and
wherein the one or more processors are configured to execute the instructions to derive a comprehensive recognition result by integrating the plurality of recognition results.

15. The recognition device according to claim 9,
wherein the recognition result for each time width is acquired by executing the selecting the specified number of pieces of the feature data and the deriving the recognition result for each of a plurality of different specified time widths, and
wherein the one or more processors are configured to execute the instructions to derive a final recognition result by integrating the recognition results for each of the time widths.

16. A data processing system comprising:
the recognizer training device according to claim 1; and
a recognition device,
wherein the recognition device comprises one or more memories storing instructions and one or more processors configured to execute the instructions to:
set a data range whose length is a specified time width to a set of feature data to which a time is added, and select a specified number of pieces of the feature data from within the data range;
derive a recognition result by inputting, to a recognizer, a selected plurality of pieces of feature data, whose time order is retained; and
output information based on the recognition result.

17. A data processing method for training a recognizer that outputs a recognition result by using a time series of feature data as an input, the data processing method comprising:
setting a data range whose length is a specified time width to a set of feature data to which a time is added, and selecting a specified number of pieces of the feature data from within the data range;
adding a teacher label corresponding to the recognition result to the selected plurality of pieces of feature data, whose time order is retained, based on information regarding the plurality of pieces of feature data; and
training the recognizer by using, as training data, a set of the plurality of pieces of feature data, whose time order is retained, and the teacher label.

18-27. (canceled)

28. A non-transitory computer-readable storage medium recorded with a program for training a recognizer that outputs a recognition result by using a time series of feature data as an input, the program causing a computer to execute:
feature data selection processing of setting a data range whose length is a specified time width to a set of feature data to which a time is added, and selecting a specified number of pieces of the feature data from within the data range;
label addition processing of adding a teacher label corresponding to the recognition result to a plurality of pieces of feature data, which is selected by the feature data selection processing and whose time order is retained, based on information regarding the plurality of pieces of feature data; and
training processing of training the recognizer by using, as training data, a set of the plurality of pieces of feature data, whose time order is retained, and the teacher label added by the label addition processing.

29-38. (canceled)
